(19) United States
(12) Patent Application Publication
(10) Pub. No.: US 2025/0246193 A1
(43) Pub. Date: Jul. 31, 2025

(54) VOICE DISPLAY DEVICE, VOICE DISPLAY SYSTEM, VOICE DISPLAY METHOD, AND STORAGE MEDIUM

(71) Applicant: HONDA MOTOR CO., LTD., Tokyo (JP)

(72) Inventors: Naoaki Sumida, Wako-shi (JP); Masaki Nakatsuka, Wako-shi (JP); Yui Sudo, Wako-shi (JP); Kyosuke Hineno, Hayami-gun (JP); Kazuya Maura, Hayami-gun (JP); Yuri Harada, Hayami-gun (JP)

(21) Appl. No.: 19/023,457

(22) Filed: Jan. 16, 2025

(30) Foreign Application Priority Data
Jan. 25, 2024 (JP) 2024-009702

(51) Int. Cl. G10L 15/26; G08B 6/00; G10L 15/22

(52) U.S. Cl. CPC G10L 15/26; G10L 15/22; G08B 6/00; G10L 2015/223; G10L 2015/227

(57) ABSTRACT

A voice display device includes: an acquisition unit configured to acquire a voice signal; a voice recognizing unit configured to recognize the acquired voice signal; a display unit configured to display a voice recognition result; and a processing unit configured to start an application for displaying the voice recognition result of the voice signal including a wake word when the wake word is acquired and to cause the display unit to display the voice recognition result of the voice signal including the wake word.

### CROSS-REFERENCE TO RELATED APPLICATION

Priority is claimed on Japanese Patent Application No. 2024-009702, filed Jan. 25, 2024, the content of which is incorporated herein by reference.

### BACKGROUND OF THE INVENTION

### Field of the Invention

The present invention relates to a voice display device, a voice display system, a voice display method, and a storage medium.

### Description of Related Art

For example, a conference support system that recognizes speech uttered by persons and displays recognized text on a screen has been proposed for hearing-impaired persons (for example, see Patent Document 1). This system is used, for example, in internal meetings.

[Patent Document 1] Japanese Patent No. 6548045

### SUMMARY OF THE INVENTION

There is demand for using the system according to the related art not only for conferences but also for collecting information in emergencies. However, in the related art, it is difficult to use the system to collect information in emergency.

An aspect of the present invention was invented in consideration of the aforementioned circumferences, and an objective thereof is to provide a voice display device, a voice display system, a voice display method, and a storage medium that can be used to collect information in emergency.

In order to solve the aforementioned problem and to achieve the objective, the present invention employs the following aspects.

(1) A voice display device according to an aspect of the present invention includes: an acquisition unit configured to acquire a voice signal; a voice recognizing unit configured to recognize the acquired voice signal; a display unit configured to display a voice recognition result; and a processing unit configured to start an application for displaying the voice recognition result of the voice signal including a wake word when the wake word is acquired and to cause the display unit to display the voice recognition result of the voice signal including the wake word.

(2) In the aspect of (1), the application may display the voice recognition result of the voice signal including the wake word on a first screen image, a plurality of function selection button images may be displayed on the first screen image, and, when one of the plurality of function selection button images is selected, the processing unit may transition to a second screen image corresponding to the selected function selection button image and display an image indicating that a user of the voice display device is a hearing-impaired person on the second screen image.

(3) In the aspect of (2), the second screen image may include a voice acquisition button image, and, when the voice acquisition button image is selected, the processing unit may acquire a voice signal of a speaker, recognize the acquired voice signal of the speaker, convert the voice recognition result to text, and display the text in the second screen image.

(4) In the aspect of any one of (1) to (3), the voice display device may further include a vibration unit configured to give an alarm by vibration, and the processing unit may start an application for displaying the voice recognition result of a voice signal including a wake word when the wake word is acquired and give an alarm by vibration of the vibration unit.

(5) A voice display system according to another aspect of the present invention includes a voice display device and an information processing device, the voice display device includes an acquisition unit configured to acquire a voice signal, a voice recognizing unit configured to recognize the acquired voice signal, a communication unit configured to transmit a voice recognition result to the information processing device and to receive a detection result of a wake word from the information processing device, a display unit configured to display the voice recognition result, and a processing unit configured to start an application for displaying the voice recognition result of a voice signal including a wake word when the wake word is acquired and to cause the display unit to display the voice recognition result of the voice signal including the wake word, and the information processing device includes an information processing device processing unit configured to receive the voice recognition result from the voice display device, to determine whether the wake word is included in the voice recognition result, and to transmit information indicating that the wake word is included and a phrase including the wake word to the voice display device when the wake word is included in the voice recognition result.

(6) A voice display method according to another aspect of the present invention includes: causing an acquisition unit to acquire a voice signal; causing a voice recognizing unit to recognize the acquired voice signal; causing a display unit to display a voice recognition result; and causing a processing unit to start an application for displaying the voice recognition result of the voice signal including a wake word when the wake word is acquired and to cause the display unit to display the voice recognition result of the voice signal including the wake word.

(7) A non-transitory computer-readable storage medium according to another aspect of the present invention stores a program causing a computer of a voice display device to perform: acquiring a voice signal; recognizing the acquired voice signal; displaying a voice recognition result; and starting an application for displaying the voice recognition result of the voice signal including a wake word when the wake word is acquired and displaying the voice recognition result of the voice signal including the wake word.

According to the aspects of (1) to (7), it is possible to use the aspects to collect information in emergency. According to the aspects of (1) to (7), even a person having difficulty in hearing or a hearing-impaired person can be aware of an emergency broadcast in the region and understand details of the emergency broadcast.

### BRIEF DESCRIPTION OF THE DRAWINGS

FIG. 1 is a diagram illustrating an example of a situation in which there is an emergency broadcast in a commercial facility or the like.

FIG. 2 is a diagram illustrating an example of a configuration of a voice display system according to a first embodiment.

FIG. 3 is a diagram illustrating an example of information that is stored in a storage unit.

FIG. 4 is a diagram illustrating an example of a first screen and a second screen which are displayed on an image display unit of a mobile terminal according to an embodiment.

FIG. 5 is a flowchart illustrating a process flow that is performed by a mobile terminal according to the first embodiment.

FIG. 6 is a diagram illustrating an example of a configuration of a voice display system according to a second embodiment.

FIG. 7 is a flowchart illustrating a process flow that is performed by a mobile terminal and an information processing device according to the second embodiment.

### DETAILED DESCRIPTION OF THE INVENTION

Hereinafter, embodiments of the present invention will be described with reference to the accompanying drawings. In the drawings used for the following description, scales of elements are appropriately changed to easily recognize the elements.

In all the drawings used for description of the embodiments, elements having the same or similar functions will be referred to by the same reference signs, and repeated description thereof will be omitted.

“On the basis of XX” mentioned in this specification means “on the basis of at least XX” and includes “on the basis of another element in addition to XX.” “On the basis of XX” is not limited to direct use of XX and includes use of results obtained by performing calculation or processing on XX. “XX” is an arbitrary factor (for example, arbitrary information).

### Summary

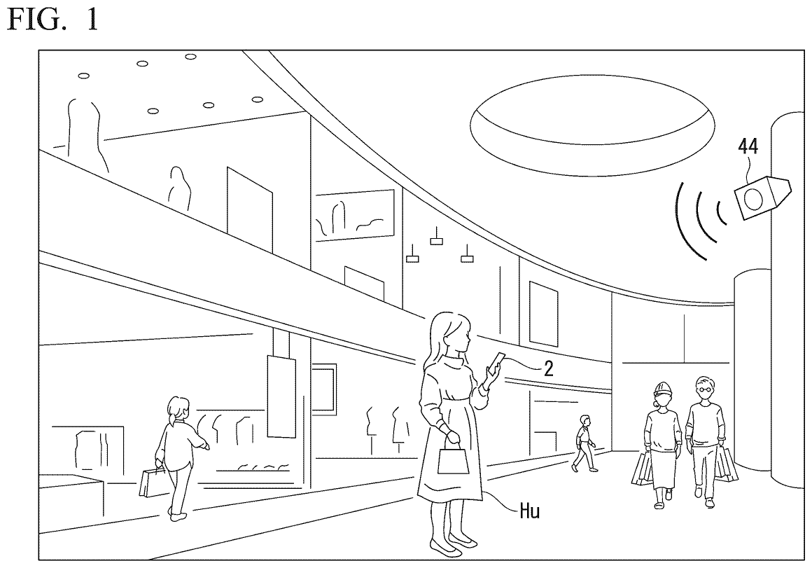

FIG. 1 is a diagram illustrating an example of a situation in which there is an emergency broadcast in a commercial facility or the like. These days, announcement, regional broadcast, or the like may be made in stations, railway trains, large-scale commercial facilities, or the like. A hearing-normal person can be aware of such a broadcast. However, when a person in the region is a person having difficulty in hearing or a hearing-impaired person, they may not be able to be aware of such an emergency broadcast.

Accordingly, in the present embodiments, for example, when an emergency broadcast is made by an alarm unit 44 of a regional broadcast device 4, an application is started on the basis of a word included in the broadcast, and an emergency broadcast detection screen (a first screen) is displayed on a mobile terminal 2 of a user Hu. For example, details of the emergency broadcast are auditorily recognized and are displayed as text in the emergency broadcast detection screen. In the present embodiments, an image of “HELP button” or the like can be displayed on a first screen to ask for help to nearby persons.

### First Embodiment

In a first embodiment, an example in which a mobile terminal starts an application to perform processing at time of emergency broadcast will be described.

### Example of Configuration of Voice Display System

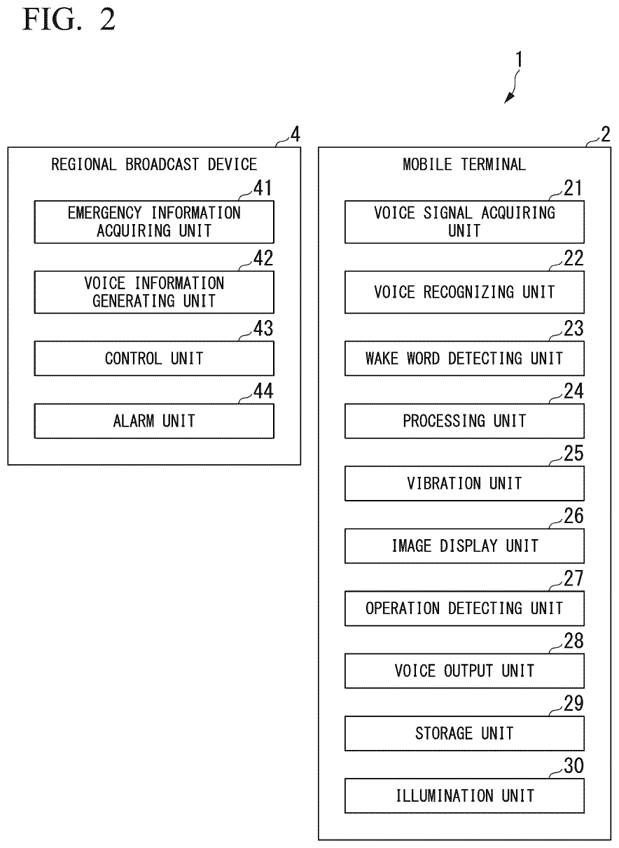

FIG. 2 is a diagram illustrating an example of a configuration of a voice display system according to a first embodiment.

As illustrated in FIG. 2, the voice display system 1 includes, for example, a mobile terminal 2 (a voice display device) and a regional broadcast device 4.

The mobile terminal 2 includes, for example, a voice signal acquiring unit 21, a voice recognizing unit 22, a wake word detecting unit 23, a processing unit 24, a vibration unit 25, an image display unit 26, an operation detecting unit 27, a voice output unit 28, a storage unit 29, and an illumination unit 30.

The regional broadcast device 4 includes an emergency information acquiring unit 41, a voice information generating unit 42, a control unit 43, and an alarm unit 44.

The regional broadcast device 4 is, for example, a broadcast system that is used in a station, a ward office, a commercial facility, a department store, a supermarket, a shopping center, or the like.

The emergency information acquiring unit 41 acquires emergency information from, for example, the government, the prefectures, the cities, towns, and villages, the Meteorological Agency, and the Defense Agency. The emergency information acquiring unit 41 acquires emergency information from, for example, a security guard when an emergency (such as a fire, a suspicious object, or a suspicious person) has occurred or been found in the region.

The voice information generating unit 42 generates an emergency voice signal for giving an alarm by regional broadcast. The emergency voice signal may be generated, for example, by allowing a regional announcer to directly read a manuscript or may be a recording made in advance.

When emergency information has been acquired and an emergency voice signal has been generated, the control unit 43 causes the alarm unit 44 to emit the generated emergency voice signal.

The alarm unit 44 is, for example, a speaker. The alarm unit 44 issues an emergency voice signal under the control of the control unit 43.

The mobile terminal 2 is, for example, a smartphone or a tablet terminal including a display unit, a speaker, and a microphone.

The voice signal acquiring unit 21 is, for example, a microphone. The number of microphones may be two or more. The voice signal acquiring unit 21 acquires a voice signal.

The voice recognizing unit 22 performs a known voice recognizing process (such as noise reduction, sound source separation, language analysis, and conversion to text) on the acquired voice signal. The voice recognizing unit 22 outputs text for each sound source to the wake word detecting unit 23.

The wake word detecting unit 23 determines whether a wake word stored in the storage unit 29 is included in the text. When a wake word is included in the text, the wake word detecting unit 23 outputs the wake word included in the text and information indicating that the wake word is included to the processing unit 24. The wake word detecting unit 23 extracts a phrase including the wake word from the text for each speech output from the voice recognizing unit 22 and outputs the extracted phrase to the processing unit 24.

When the wake word included in the text and information indicating that the wake word is included are acquired from the wake word detecting unit 23, the processing unit 24 starts an application for an emergency broadcast stored in the storage unit 29 and displays a display screen (a first screen) corresponding to the wake word on the image display unit 26 while causing the vibration unit 25 to vibrate. The processing unit 24 displays a phrase including the wake word in the first screen. An example of the first screen will be described later. When a button image (a function selection button image) in the first screen is operated, the processing unit 24 performs a process corresponding to the button image. An example of the button image and an example of the process corresponding to the button image will be described later.

The vibration unit 25 generates vibration according to the process of the processing unit 24. The vibration unit 25 generates vibration, for example, by rotation of a vibrator connected to a rotation shaft of a motor. Through this vibration, a person having difficulty in hearing or a hearing-impaired person can be aware that there is an emergency broadcast.

The image display unit 26 displays the first screen and a second screen corresponding to the button image under the control of the processing unit 24.

The operation detecting unit 27 is, for example, a touch panel sensor that is provided on the image display unit 26. The operation detecting unit 27 detects a user's operation (touch, swiping, or the like) and outputs the detection result to the processing unit 24.

The voice output unit 28 is, for example, a speaker. The voice output unit 28 may output, for example, text displayed in the first screen to a user who is a person intending to give help or a person wanting help through processing of the processing unit 24.

The storage unit 29 stores a display image to be displayed in correlation with the wake word. The storage unit 29 stores an application for an emergency broadcast.

The illumination unit 30 is, for example, a light using a light emitting diode (LED). The illumination unit 30 switches between turning-on and turning-off of the light under the control of the processing unit 24.

### Wake Word

A wake word, information stored in the storage unit 29, and the like will be described below.

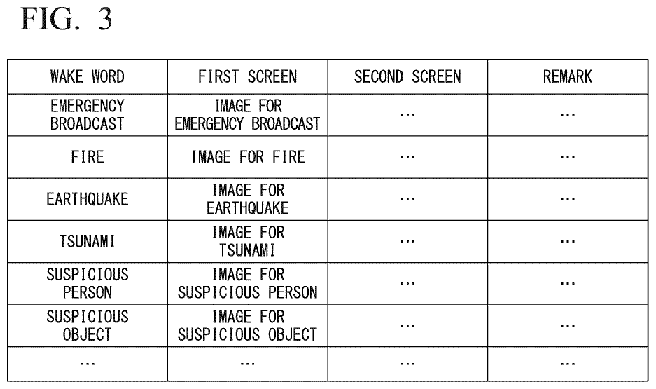

FIG. 3 is a diagram illustrating an example of information stored in the storage unit. The storage unit 29 stores a first screen and a second screen which is displayed according to a button image included in the first screen in correlation with a wake word.

Examples of the wake word include “emergency broadcast,” “fire,” “earthquake,” “tsunami,” “suspicious person,” and “suspicious object.” The wake word may be, for example, only “emergency broadcast.”

The first screen is an image matching a wake word. An image of the first screen may be shared by the wake words.

The second screen is an image for each button image in the first screen.

The storage unit 29 may store other information other than described above in correlation.

### Example of Image Displayed on Mobile Terminal and Example of Button Image

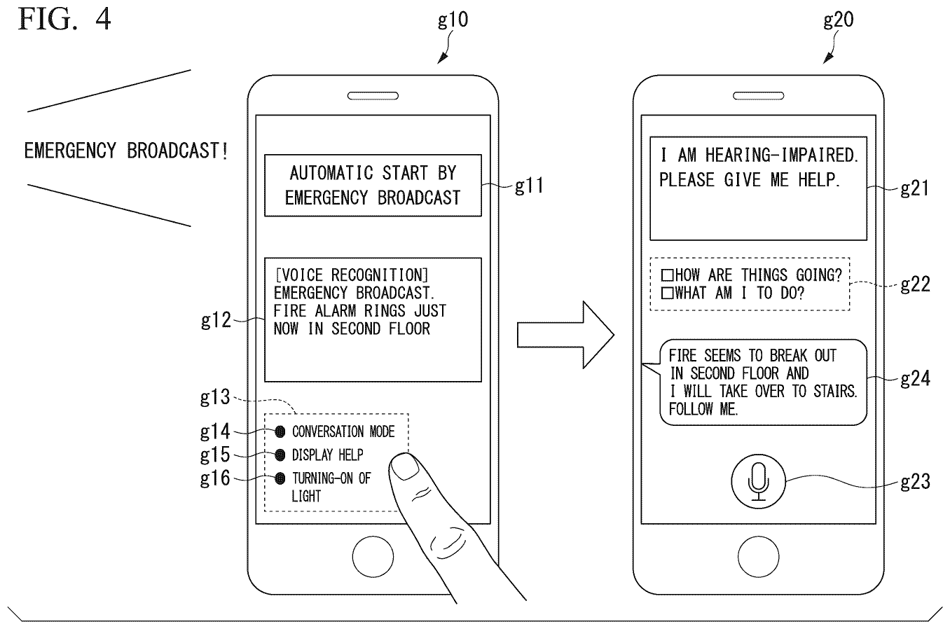

An example of an image displayed on the image display unit 26 of the mobile terminal 2 will be described below. FIG. 4 is a diagram illustrating an example of the first screen and the second screen which are displayed on the image display unit of the mobile terminal according to the present embodiment.

An image g10 is an example in which an application for an emergency broadcast is started and a first screen is displayed when a voice signal of the emergency broadcast is acquired and a wake word is detected.

An image g11 is an example of an image indicating that an application has been automatically started due to an emergency broadcast.

An image g12 is an image of an example in which a voice signal of an emergency broadcast is recognized and converted to text online and the text is displayed.

An area of an image g13 is an example of a button image. An image g14 is a button image of a “conversation mode” with a person intending to give help or a person wanting help. An image g15 is a button image for “display HELP” to a person intending to give help or a person wanting help. An image g16 is a button image of “turning-on of H light.”

An image g20 is an example of an image of a second screen which is displayed, for example, when the button image g14 of “display HELP” is operated by a user.

An image g21 is an example of an image indicating reasons for help. These details may be set in advance by allowing a user to select the details from fixed phrases or may be input and set by allowing a user to operate a software keyboard or the like displayed on the image display unit 26.

An image g22 is an example of an image indicating question details. For example, these details are registered in the application in advance. A user may ask a question, for example, by selecting a sentence of question details.

An image g23 is an example of a spoken voice acquisition button which is selected to acquire speech of a conversation partner (a person intending to give help or a person wanting help). Text such as “push this button at the time of start of speaking” may also be displayed.

An image g24 is an example of an image in which a speech of a conversation partner (a person intending to give help or a person wanting help) is processed and recognized online and is displayed as text.

### Example of Process Flow

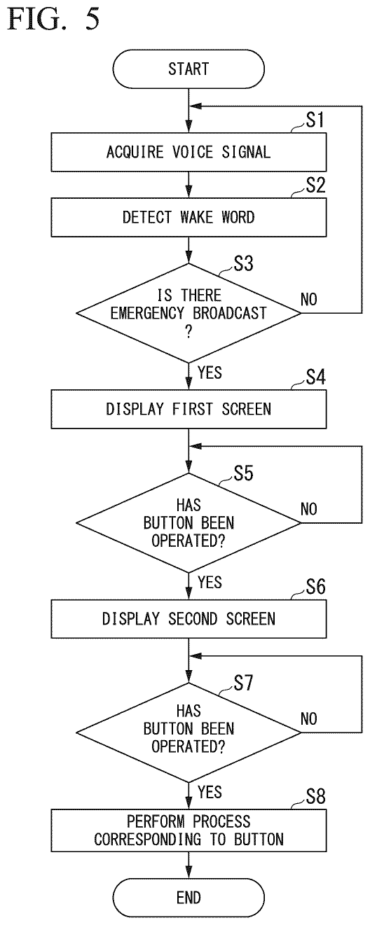

A process flow that is performed by the mobile terminal 2 will be described below. FIG. 5 is a flowchart illustrating a process flow that is performed by a mobile terminal according to the present embodiment. In the following description, for example, it is assumed that a wake word is “emergency broadcast.”

(Step S1) The voice signal acquiring unit 21 acquires a voice signal.

(Step S2) The wake word detecting unit 23 determines whether a wake word stored in the storage unit 29 is included in text. When a wake word is included in text, the wake word detecting unit 23 outputs the wake word included in the text and information indicating that the wake word is included in the text to the processing unit 24.

(Step S3) The processing unit 24 determines whether the wake word “emergency broadcast” has been detected from the voice signal using the information output from the wake word detecting unit 23. When the wake word “emergency broadcast” has been detected (Step S3: YES), the processing unit 24 causes the process flow to proceed to Step S4. When the wake word “emergency broadcast” has not been detected (Step S3: NO), the processing unit 24 returns the process flow to Step S1.

(Step S4) For example, the processing unit 24 causes the vibration unit 25 to vibrate for a predetermined time, starts an application for an emergency broadcast, and displays a first screen in which the wake word is “emergency broadcast” on the image display unit 26. When a plurality of wake words are set, the processing unit 24 performs the process of Step S4 on each wake word.

(Step S5) The processing unit 24 determines whether one of button images in the first screen has been operated on the basis of the detection result from the operation detecting unit 27. When one of the button images has been operated (Step S5: YES), the processing unit 24 causes the process flow to proceed to Step S6. When one of the button images has not been operated (Step S5: NO), the processing unit 24 repeats the process of Step S5.

(Step S6) The processing unit 24 selects an image of the second screen corresponding to the selected button image and switches the display on the image display unit 26 from the first screen to the second screen.

(Step S7) The processing unit 24 determines whether a button image (for example, the image g23 in FIG. 4) in the second screen has been selected. When a button image in the second screen has been selected (Step S7: YES), the processing unit 24 causes the process flow to proceed to Step S8. When a button image in the second screen has not been selected (Step S7: NO), the processing unit 24 repeats the process of Step S7.

(Step S8) The processing unit 24 performs a process corresponding to the button image selected in the second screen, for example, a process of recognizing a voice and converting the voice to text.

The process flow and the process details described above with reference to FIG. 5 are only examples, and the present invention is not limited thereto. The mobile terminal 2 may perform other processes.

As described above, in the present embodiment, when a wake word included in an emergency broadcast is recognized, an application for an emergency broadcast is started, and an emergency broadcast detection screen (the first screen) is displayed. Accordingly, according to the present embodiment, since a broadcast voice heard in the region can be recognized and displayed, a user such as a hearing-impaired person can be aware of the emergency broadcast.

In the present embodiment, the button “display HELP” or the like is displayed in the emergency broadcast detection screen. Accordingly, according to the present embodiment, when the button is pressed, predetermined text indicating that the user is a hearing-impaired person or the like can be displayed, and a nearby hearing-normal person can be asked for help.

### Second Embodiment

In the first embodiment, an example in which all the processes are performed by the mobile terminal 2 has been described, but the present invention is not limited thereto. Some of the processes, for example, the voice recognizing process, the wake word detecting process, or the process of generating the first screen or the second screen may be performed by an information processing device 5.

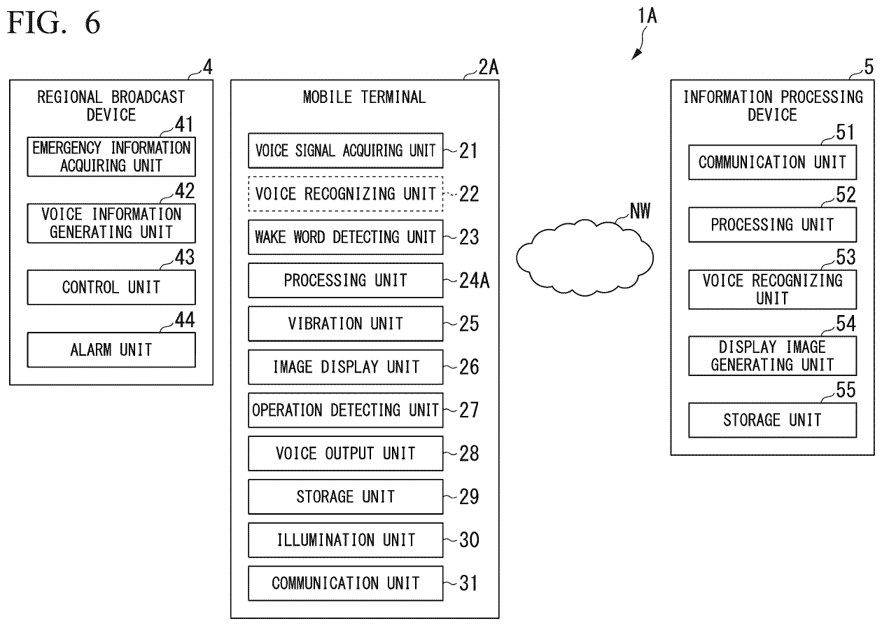

FIG. 6 is a diagram illustrating an example of a configuration of a voice display system according to a second embodiment.

As illustrated in FIG. 6, a voice display system 1A includes, for example, a mobile terminal 2A (a voice display device), a regional broadcast device 4, and an information processing device 5.

The mobile terminal 2A includes, for example, a voice signal acquiring unit 21, a voice recognizing unit 22, a wake word detecting unit 23, a processing unit 24A, a vibration unit 25, an image display unit 26, an operation detecting unit 27, a voice output unit 28, a storage unit 29, an illumination unit 30, and a communication unit 31.

The regional broadcast device 4 includes, for example, an emergency information acquiring unit 41, a voice information generating unit 42, a control unit 43, and an alarm unit 44.

The information processing device 5 includes, for example, a communication unit 51 (an information processing device communication unit), a processing unit 52 (an information processing device processing unit), a voice recognizing unit 53 (an information processing device voice recognizing unit), a display image generated unit 54, and a storage unit 55.

The communication unit 31 transmits and receives information to and from the information processing device 5 via a network NW. The network NW is based on a wireless line and is, for example, the Internet.

The processing unit 24A transmits, for example, an acquired voice signal to the information processing device 5 via the communication unit 31. The processing unit 24A acquires a voice recognition result from the information processing device 5.

The information processing device 5 is, for example, a server or a personal computer.

The communication unit 51 receives information (for example, a voice signal) from the mobile terminal 2A and outputs the received voice signal to the processing unit 52. The communication unit 51 transmits information (for example, a voice recognition result) output from the processing unit 52 to the mobile terminal 2A under the control of the processing unit 52. The communication unit 51 transmits image data of the first screen or the second screen generated by the display image generated unit 54 to the mobile terminal 2A.

The processing unit 52 outputs the voice signal received by the communication unit 51 to the voice recognizing unit 53. The processing unit 52 transmits text information which is the voice recognition result from the voice recognizing unit 53 to the mobile terminal 2A via the communication unit 51. The processing unit 52 transmits the image data generated by the display image generated unit 54 to the mobile terminal 2A via the communication unit 51. The processing unit 52 may detect a wake word from the text obtained through a voice recognizing process.

The voice recognizing unit 53 performs a predetermined voice recognizing process on the received voice signal.

The display image generated unit 54 generates image data of the first screen or the second screen.

The storage unit 55 stores programs which are used by the functional units, a threshold value, a wake word, image data of the first screen, image data of the second screen, and the like.

All or some of the processes that are performed by the information processing device 5 may be performed over cloud.

### Example of Process Flow Performed by Mobile Terminal and Information Processing Device

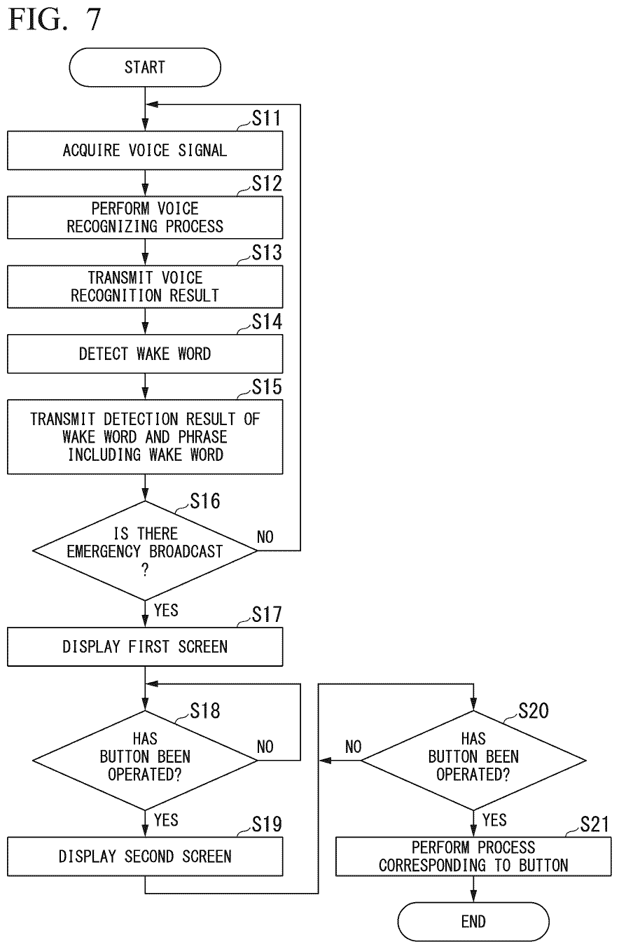

A process flow that is performed by the mobile terminal 2A and the information processing device 5 will be described below. FIG. 7 is a flowchart illustrating a process flow that is performed by a mobile terminal and the information processing device according to the present embodiment. In the example illustrated in FIG. 7, for example, a voice is recognized by the information processing device 5.

(Step S11) The voice signal acquiring unit 21 of the mobile terminal 2A acquires a voice signal.

(Step S12) The voice recognizing unit 22 of the mobile terminal 2A performs a voice recognizing process on the acquired voice signal using a known method.

(Step S13) The processing unit 24A of the mobile terminal 2A transmits a voice recognition result to the information processing device 5 via the communication unit 31. Identification information for identifying the mobile terminal 2A is assigned to the voice recognition result which is transmitted.

(Step S14) The processing unit 52 of the information processing device 5 receives the voice recognition result via the communication unit 51. The voice recognizing unit 53 detects a wake word from the voice recognition result received by the processing unit 52.

(Step S15) When a wake word is included in text, the processing unit 52 of the information processing device 5 transmits the wake word included in the text and information indicating that the wake word is included to the mobile terminal 2A via the communication unit 51.

(Step S16) The processing unit 24A of the mobile terminal 2A determines whether a wake word “emergency broadcast” has been detected from the voice signal using information output from the wake word detecting unit 23. When the wake word “emergency broadcast” has been detected (Step S16: YES), the processing unit 24A causes the process flow to proceed to Step S17. When the word “emergency broadcast” has not been detected (Step S16: NO), the processing unit 24A returns the process flow to Step S11.

(Step S17) The processing unit 24A of the mobile terminal 2A causes the vibration unit 25 to vibrate for a predetermined time, starts an application for an emergency broadcast, and displays the first screen in which the wake word is “emergency broadcast” on the image display unit 26. When a plurality of wake words are set, the processing unit 24A performs the process of Step S17 on each wake word.

(Step S18) The processing unit 24A of the mobile terminal 2A determines whether one of button images in the first screen has been operated on the basis of the detection result from the operation detecting unit 27. When one of the button images has been operated (Step S18: YES), the processing unit 24A causes the process flow to proceed to Step S19. When one of the button images has not been operated (Step S18: NO), the processing unit 24A repeats the process of Step S18.

(Step S19) The processing unit 24A of the mobile terminal 2A selects an image of the second screen corresponding to the selected button image and switches the display on the image display unit 26 from the first screen to the second screen.

(Step S20) The processing unit 24A of the mobile terminal 2A determines whether a button image (for example, the image g23 in FIG. 4) in the second screen has been selected. When a button image in the second screen has been selected (Step S20: YES), the processing unit 24A causes the process flow to proceed to Step S21. When a button image in the second screen has not been selected (Step S20: NO), the processing unit 24A repeats the process of Step S20.

(Step S21) The processing unit 24A of the mobile terminal 2A performs a process corresponding to the button image selected in the second screen, for example, a process of recognizing a voice and converting the voice to text.

The process flow and the process details described above with reference to FIG. 7 are only examples, and the present invention is not limited thereto. The information processing device 5 may perform a voice recognizing process on a voice signal acquired by the mobile terminal 2A online and transmit the voice recognition result to the mobile terminal 2A.

As described above, in the present embodiment, the information processing device 5 performs some of the processes performed by the mobile terminal 2A. Accordingly, according to the present embodiment, it is possible to reduce the processes of the mobile terminal 2A.

### Application Example

In the aforementioned examples, it is assumed that a user of a mobile terminal 2 is a person having difficulty in hearing or a hearing-impaired person in the region, but the present invention is not limited thereto. These days, persons often walk in such an environment with an earphone worn thereon. These persons may not be aware of an emergency broadcast. On the other hand, by performing setting of the mobile terminal 2 according to the present embodiment, even a person using an earphone can be first notified by vibration and additionally made to be aware that there is an emergency broadcast through the first screen. Accordingly, the method or device according to the present embodiment can also be applied to persons other than a person having difficulty in hearing or a hearing-impaired person in the region.

Some or all of the processes which are performed by the mobile terminal 2 (or 2A) and the information processing device 5 may be performed by recording a program for realizing all or some of the functions of the mobile terminal 2 (or 2A) and the information processing device 5 according to the present invention on a computer-readable recording medium and causing a computer system to read and execute the program recorded on the recording medium. The “computer system” mentioned herein includes an operating system (OS) or hardware such as peripherals. The “computer system” may include a WWW system including a homepage provision environment (or a homepage display environment). The “computer-readable recording medium” is a portable medium such as a flexible disk, a magneto-optical disc, a ROM, or a CD-ROM or a storage device such as a hard disk incorporated into a computer system. The “computer-readable recording medium” may include a medium that holds a program for a predetermined time such as a volatile memory (RAM) in a computer system serving as a server or a client when the program is transmitted via a network such as the Internet or a communication line such as a telephone line.

Some or all of these elements may be realized by hardware (a circuit unit including circuitry) such as a large scale integration (LSI) circuit, an application-specific integrated circuit (ASIC), a field-programmable gate array (FPGA), a graphics processing unit (GPU) or a system on chip (SOC) or may be cooperatively realized by software and hardware.

The program may be transmitted from a computer system in which the program is stored in a storage device or the like to another computer system via a transmission medium or carrier waves in the transmission medium. Here, the “transmission medium” for transmitting a program is a medium having a function of transmitting information such as a network (a communication network) such as the Internet or a communication circuit line (a communication line) such as a telephone line. The program may be a program for realizing some of the aforementioned functions. The program may be a so-called differential file (a differential program) that can realize the aforementioned functions in combination with another program stored in advance in the computer system.

While a mode for realizing the present invention has been described above with reference to an embodiment, the present invention is not limited to the embodiment and can be subjected to various modifications and replacements without departing from the gist of the present invention.

What is claimed is:

1. A voice display device comprising:
an acquisition unit configured to acquire a voice signal;
a voice recognizing unit configured to recognize the acquired voice signal;
a display unit configured to display a voice recognition result; and
a processing unit configured to start an application for displaying the voice recognition result of the voice signal including a wake word when the wake word is acquired and to cause the display unit to display the voice recognition result of the voice signal including the wake word.

2. The voice display device according to claim 1, wherein the application displays the voice recognition result of the voice signal including the wake word on a first screen image,
wherein a plurality of function selection button images are displayed on the first screen image, and
wherein, when one of the plurality of function selection button images is selected, the processing unit transitions to a second screen image corresponding to the selected function selection button image and displays an image indicating that a user of the voice display device is a hearing-impaired person on the second screen image.

3. The voice display device according to claim 2, wherein the second screen image includes a voice acquisition button image, and
wherein, when the voice acquisition button image is selected, the processing unit acquires a voice signal of a speaker, recognizes the acquired voice signal of the speaker, converts the voice recognition result to text, and displays the text in the second screen image.

4. The voice display device according to claim 1, further comprising a vibration unit configured to give an alarm by vibration,
wherein the processing unit starts an application for displaying the voice recognition result of a voice signal including a wake word when the wake word is acquired and gives an alarm by vibration of the vibration unit.

5. A voice display system comprising:
a voice display device; and
an information processing device,
wherein the voice display device includes
an acquisition unit configured to acquire a voice signal,
a voice recognizing unit configured to recognize the acquired voice signal,
a communication unit configured to transmit a voice recognition result to the information processing device and to receive a detection result of a wake word from the information processing device,
a display unit configured to display the voice recognition result, and
a processing unit configured to start an application for displaying the voice recognition result of a voice signal including a wake word when the wake word is acquired and to cause the display unit to display the voice recognition result of the voice signal including the wake word, and
wherein the information processing device includes an information processing device processing unit configured to receive the voice recognition result from the voice display device, to determine whether the wake word is included in the voice recognition result, and to transmit information indicating that the wake word is included and a phrase including the wake word to the voice display device when the wake word is included in the voice recognition result.

6. A voice display method comprising:
causing an acquisition unit to acquire a voice signal;
causing a voice recognizing unit to recognize the acquired voice signal;
causing a display unit to display a voice recognition result; and
causing a processing unit to start an application for displaying the voice recognition result of the voice signal including a wake word when the wake word is acquired and to cause the display unit to display the voice recognition result of the voice signal including the wake word.

7. A non-transitory computer-readable storage medium storing a program causing a computer of a voice display device to perform:
acquiring a voice signal;
recognizing the acquired voice signal;
displaying a voice recognition result; and
starting an application for displaying the voice recognition result of the voice signal including a wake word when the wake word is acquired and displaying the voice recognition result of the voice signal including the wake word.
